(19) United States
(12) Patent Application Publication
(10) Pub. No.: US 2024/0255951 A1
(43) Pub. Date: Aug. 1, 2024

(54) SYSTEM AND METHOD OF CONTROL BASED ON HEAD POSE ESTIMATION

(71) Applicants: Austin Garrison, Russellville, MO (US); Aaron Harrison, Barnhart, MO (US); Joshua Harmon, Columbia, MO (US)

(72) Inventors: Austin Garrison, Russellville, MO (US); Aaron Harrison, Barnhart, MO (US); Joshua Harmon, Columbia, MO (US)

(21) Appl. No.: 18/419,323

(22) Filed: Jan. 22, 2024

Related U.S. Application Data
(60) Provisional application No. 63/482,100, filed on Jan. 30, 2023.

(51) Int. Cl. G05D 1/222; G06F 3/01; G06V 40/16

(52) U.S. Cl. CPC G05D 1/222; G06F 3/012; G06V 40/165

(57) ABSTRACT

A computing device can track an operator's head movements and move a lighting system and/or other motor control operations controlled by one or more auxiliary devices according to the operator's head movements via a motor control processor. The motor control processor can facilitate movement by one or more auxiliary devices by continuously monitoring the operator's head movements via camera and moving the auxiliary devices in a manner that mimics the motion of the operator's head. The auxiliary devices may move the lighting system and/or other motor control system in one or more dimensions. The operator can move the lighting system and illuminate a specific area with a head movement. The lighting system can dynamically direct lighting in the direction that the operator is facing while freeing the operator's hands for a primary task.

### CROSS-REFERENCE TO RELATED APPLICATIONS

The present application claims the priority benefit of U.S. Provisional Patent Application No. 63/482,100 filed Jan. 30, 2023, and titled “System and Method of Control Based on Head Pose Estimation,” the disclosure of which is incorporated by reference herein.

### TECHNICAL FIELD

This disclosure generally relates to motor control; and more specifically to motor control based on head pose estimation of an operator to achieve dynamic movement that allows for hands-free operation of a lighting system and/or other motor control operations.

### BACKGROUND

Lighting systems and/or other motor control operations typically are controlled via remote control, predetermined movements, manually moved by an operator, are immobile, or the like. Restrictions in light system technology do not allow for optimum performance in fields such as heavy machinery operation, medical applications, defense, and the like. Operators in the aforementioned fields are required to operate the lighting systems in conjunction with their primary task (e.g., operating a tractor at night, operating on a patient, pursuing a criminal at night, etc.) or may not be capable of altering the lighting system during their primary task. Operators may not be able to perform their primary task due to the deficiencies in the lighting system controls.

### SUMMARY

Methods and systems are described herein for controlling a lighting system and/or other motor control operations based on head pose estimation. The methods include: receiving a representation of a movement associated with the operator, wherein the representation of the movement includes a first set of one or more two-dimensional vectors; receiving an identification of a location from an auxiliary device, wherein the identification includes a second set of one or more two-dimensional vectors; generating instructions for the auxiliary device to perform an auxiliary movement by comparing the first set of one or more two-dimensional vectors and the second set of one or more two-dimensional vectors, wherein the auxiliary movement is to imitate the movement associated with the operator; and outputting the instructions to the auxiliary device, wherein the instructions are configured to cause the auxiliary device to move according to the movement associated with the operator.

Systems are described herein for controlling a lighting system and/or other motor control operations based on head pose estimation. The systems include one or more processors and a non-transitory computer-readable medium storing instructions that, when executed by the one or more processors, cause the one or more processors to perform any of the methods as previously described.

Non-transitory computer-readable media are described herein for storing instructions that, when executed by the one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example system of lighting system control and/or other motor control operations based on head pose estimation according to aspects of the present disclosure.

FIG. 2 illustrates a block diagram of an example processor configured to control a lighting system and/or other motor control operations with head pose estimation of an operator according to aspects of the present disclosure.

FIG. 3 depicts an example general assembly application of the system and method, in use on a standard tractor unit, according to aspects of the present disclosure.

FIG. 4 depicts an example configuration of the system and method, auxiliary motors within a mounting system, according to aspects of the present disclosure.

FIG. 5 illustrates a flowchart of an example process of lighting system and/or other motor control operations with control based on head pose estimation according to aspects of the present disclosure.

FIG. 6 illustrates an example computing device according to aspects of the present disclosure.

### DETAILED DESCRIPTION

Various instances of the disclosure are discussed in detail below. While specific implementations are discussed, it should be understood that this is done for illustration purposes only. A person skilled in the relevant art will recognize that other components and configurations may be used without parting from the spirit and scope of the disclosure.

In a typical lighting system, an operator may be required to either manually operate the lighting system, adapt to an immobile lighting system, or operate the lighting system through inefficient means (e.g., while attempting to perform a primary task, like operating heavy machinery, conducting surgery on a patient, law enforcement, etc.). Lighting system inefficiencies and difficulties may impact the performance of operators and/or the ability of operators to complete the primary task. For example, an operator of a tractor in a farm environment with minimal light may have to perform a primary task using the tractor with sub-optimal lighting due to the fixed nature of the lighting system on the tractor.

Accordingly, the system and method disclosed herein addresses the aforementioned issues by operating a system and a method for motor-controlled lighting and/or other motor control operations based on head pose estimation. A computing device can track an operator's head movements and move a lighting system controlled by one or more auxiliary devices according to the operator's head movements via a motor control processor. The motor control processor can facilitate movement by one or more auxiliary devices (e.g., servo motor, direct current (DC) motor, hydraulic system, etc.) by continuously monitoring the operator's head movements via camera and moving the auxiliary devices in a manner that mimics the motion of the operator's head. The auxiliary devices may move the lighting system in one or more dimensions (e.g., one, two, or three dimensions). The operator can move the lighting system and illuminate a specific area with a head movement. The lighting system, being dynamically controlled using head movements, can dynamically direct lighting in the direction that the operator is facing while freeing the operator's hands for the primary task. The motor-controlled lighting system creates the ideal environment to assist the operator in achieving peak performance while performing the primary task.

The motor control processor may receive video input from a camera directed at the operator. The motor control processor can detect a change in the position and/or orientation of an aspect of the operator by comparing a current representation of the operator (e.g., a current video frame from the video input) to one or more previous representations of the operator (e.g., one or more previous video frames from the video input). For example, the motor control processor can detect a change in the position and/or orientation of the operator's head. The motor control processor may continually monitor the aspect of the operator during operation.

A video feed transmitted to the motor control processor may be a standard definition (SD) video feed or a high definition (HD) video feed. The video may be in the infrared spectrum, radar spectrum, ultraviolet spectrum, or in another non-visible spectrum. The motor control processor may define a minimum resolution of the video feed. The minimum resolution may be based on a lowest resolution in which motor control processor can detect facial features (or other features) of the operator. The resolution of the video feed may depend on a variety of factors, including, but not limited to, lighting on the face of the operator, distance of camera from the operator, necessary response time, desired accuracy, any combination thereof, or the like.

In some embodiments, head movements of the operator may not be intended to be translated into system movements. The motor control processor may contain a manual switch that may switch modes within the motor control processor to “active” or “inactive.” When the motor control processor is placed in inactive mode, the auxiliary devices and lighting system may remain in the last known position of the auxiliary devices until the motor control processor is turned back into active mode. When the motor control processor is placed into active mode, the auxiliary devices and light system may automatically move, without receiving input from the operator, into a default “home” position. The default position is a preset location of return and/or of calibration for the auxiliary device(s).

In some embodiments, the default position is set by the operator. Before initial use of the motor control processor, the operator may initiate a calibration sequence of the motor control processor. The calibration sequence may request input from the operator regarding the desired default position of the lighting system upon re-entering active mode, activation, after system failures, any combination thereof, or the like.

When the operator's head moves, the motor control processor may calculate a degree of movement using facial landmark identifying technology and may transform the movement into an operator movement. The operator movement may be used by the motor control processor to generate movement by the auxiliary motors or other auxiliary devices. Facial landmarks may be, but are not limited to, outer and inner corners of eyes, corners of mouth, chin, tip of nose, scars, facial hair, hair line, jaw line, facial marks such as age spots or moles, wrinkles proximate to the eyes, wrinkles proximate to the forehead, wrinkles proximate to the cheeks, etc. The facial landmarks may be stored as two-dimensional and three-dimensional points within the motor control processor. The two-dimensional and three-dimensional points may be converted to translation and rotation vectors, a rotational matrix, and/or two-dimensional vector. The two-dimensional and three-dimensional points, translation and rotation vectors, rotational matrix, and two-dimensional vector may be measured against the default position of the auxiliary devices.

In some examples, the motor control processor may calculate a degree of movement using a method other than facial landmark identification. For example, the motor control processor may include an artificial intelligence module that may generate one or more machine-learning models trained to estimate head pose using deep networks from image intensities. The artificial intelligence module may generate one or more machine-learning models to estimate a loss associated with an angle (e.g., the yaw, pitch, and roll angles associated with head movement) by combining a binned pose classification and a regression component.

The auxiliary devices may be calibrated to a specific point in space and the location in space of the auxiliary devices may be continually monitored by the motor control processor. The default position may be the calibration position of the auxiliary devices. The motor control processor may continually monitor the location of the auxiliary devices by receiving data in the form of waveforms, speed, voltage, any combination thereof, or the like. The data may be manipulated to generate a location of the auxiliary devices relative to the default position in space. The default position may be used when measuring the operator movement of the operator and the location of the auxiliary devices to ensure accuracy and/or calibration of the motor control processor system.

The motor control processor may compare the operator movement to the location in space of the auxiliary devices then move the auxiliary devices accordingly to correspond with the operator's head movement. The motor control processor may compare the operator movement to a two-dimensional vector corresponding to the location of the auxiliary devices and identify discrepancies, indicating a movement that can be performed by the auxiliary devices to maintain congruency with the operator's head. The motor control processor may output a voltage or other output necessary to manipulate the speed, direction, etc. of the auxiliary devices. For example, if an operator recognizes an anomaly in the surrounding environment, the operator can merely alter their head orientation in the direction of the disturbance and the lighting system will illuminate the area. This allows the operator to focus on the primary task.

In some embodiments, there may be circumstances that do not permit standard operation of the motor control processor. The system may be moved and/or manipulated by an external input, including, but not limited to, a joystick, a mobile phone application, a remote, any combination thereof, and the like. For example, if the camera is unable to output a suitable video feed of the operator due to disturbances, an alternative method of control for the motor control processor may ensure suitable operation of the system. In some embodiments, the external input may be utilized to calibrate the lighting system and input the default position to the motor control processor.

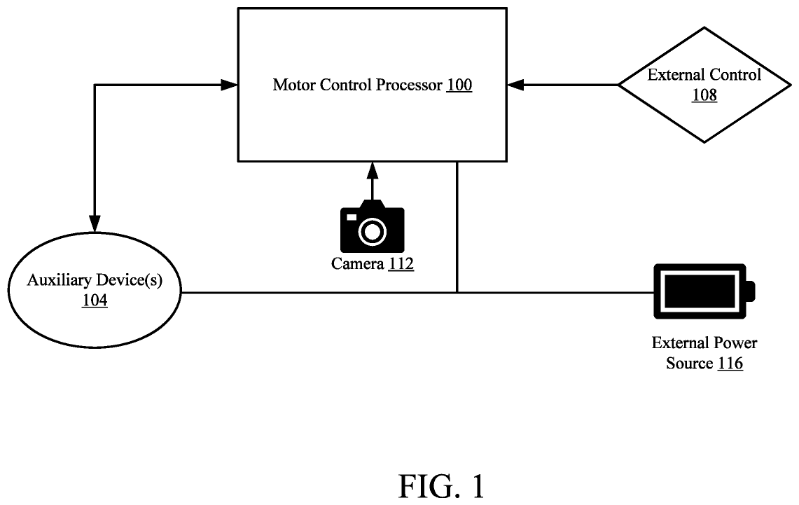

FIG. 1 illustrates a block diagram of an example system of lighting system control and/or other motor control operations based on head pose estimation according to aspects of the present disclosure. The system may be implemented using motor control processor 100.

Motor control processor 100 may receive input from camera 112. The input may be a video feed, a set of images, an image, or the like. The video may be high definition or at some resolution that is less than or greater than high definition. Motor control processor 100 may determine a resolution based on external factors impacting the video feed, including light, steadiness of the camera, accuracy required, preciseness of the operator's movements, any combination thereof, or the like. In some examples, motor control processor 100 may include an inactive mode that can be automatically triggered if the motor control processor 100 is unable to track and/or locate operator's facial landmarks from the video feed from camera 112. If the motor control processor 100 is unable to function properly, motor control processor 100 will automatically switch to inactive mode. In some embodiments, motor control processor 100 may transmit a notification to the operator notifying the operator of a video feed issue if the video feed is unusable by motor control processor 100. In some examples, camera 112 may be mounted on a device facing the applicable aspect of the operator in order to optimize the video feed. For example, camera 112 may be mounted on the dashboard of a tractor, facing the driver's seat, in order to obtain a video feed containing the operator's face.

In some examples, camera 112 may be, but is not limited to, a video-specific camera, a digital “point-and-shoot” camera with video capabilities, a digital single-lens reflex (DSLR) camera, a webcam, an infrared camera, a radar camera, a Kinect camera, a mobile phone, a smartphone, any combination thereof, or the like. Camera 112 may be connected to motor control processor 100 via wired connection, Bluetooth, universal serial bus, any combination thereof, and the like. Camera 112 may receive power from external power source 116, a separate power source from external power source 116, a rechargeable battery pack, batteries, motor control processor 100 via wired connection, and/or another power source providing power to camera 112. In some examples, camera 112 may be unable to provide the video feed to motor control processor 100 due to one or more external issues, including, but not limited to, lack of power, interference with the lens of the camera, hardware malfunction, connection problem such as electromagnetic interference, any combination thereof, or the like. If external issues occur, motor control processor 100 may transmit a notification to the operator notifying the operator of a malfunction in the camera 112 and motor control processor 100 may switch to inactive mode.

Motor control processor 100 may contain face detection software that recognizes the operator's face within the video feed received from camera 112. The face detection software may request registration of the operator. Registration of the operator may include recording the operator's face and storing characteristics of the operator's face in local memory, including, but not limited to, distance between eyes, width of head, length of nose, any combination thereof, or the like. In some examples, motor control processor 100 may recognize more than one face in the video feed. For example, the operator may have a passenger in the tractor and the camera is transmitting a video feed containing both faces. Motor control processor 100 may access the record containing the operator's face in local memory and compare the recorded facial characteristics with characteristics of the faces within the video feed. Motor control processor 100 may decipher which face is the operator using the comparison. In another example, if registration is unavailable, the operator may be prompted by motor control processor 100 to select the face of the operator if motor control processor 100 detects one or more faces within the video feed.

In some examples, motor control processor 100 may be unable to detect any faces in the video feed due to one or more external disturbances, including, but not limited to, insufficient light on the operator's face, a blockage between the lens and the operator, any combination thereof, and the like. Motor control processor 100 may send a notification to the operator notifying the operator of the issue. As mentioned previously, if motor control processor 100 is unable to identify a face in the video feed, motor control processor 100 will automatically switch to inactive mode.

Motor control processor 100 may be in inactive mode for an indefinite period of time. In some examples, motor control processor 100 may be automatically placed in inactive mode for one or more of the aforementioned reasons. If motor control processor 100 is placed in inactive mode, motor control processor 100 may continue to receive input from camera 112 and may continue to attempt to identify the operator's face. While in inactive mode, motor control processor 100 may reduce the received frame rate of the video feed and/or the rate in which video frames are processed in order to reduce power consumption. If motor control processor 100 is able to identify the operator's face after an indefinite period of time, motor control processor 100 may automatically switch to active mode and operation resumes. For example, if there is a disturbance, like a steering wheel on a tractor, that causes the operator's face to be partially concealed and therefore unidentifiable by motor control processor 100, motor control processor 100 will continue to operate the face detection software in order to resume active operation as soon as possible, however the software may slow the rate in which frames are received by the video feed and/or the rate in which video frames are processed than it would be if motor control processor 100 is operated in active mode. For example, instead of processing every frame received from the video feed, motor control processor 100 may process every fifth frame received from the video feed while operating in inactive mode. In some examples, motor control processor 100 may be placed in inactive mode manually by the operator. The inactive mode processing speed may be determined by an external variable, Boolean flag, operator input, etc.

After the face of the operator is identified, motor control processor 100 may operate facial landmark detection software to detect facial landmarks on the operator's face. Facial landmarks may include, but are not limited to, outer and inner corners of eyes, corners of mouth, chin, tip of nose, scars, facial hair, hair line, jaw line, facial marks such as age spots or moles, wrinkles proximate to the eyes, wrinkles proximate to the forehead, wrinkles proximate to the cheeks, etc. In some examples, motor control processor 100 may be unable to detect facial landmarks on the operator due to a number of disturbances, including, but not limited to, the topology of the operator's face, insufficient video feed quality, interference with the lens of camera 112, any combination thereof, or the like. If motor control processor 100 is unable to detect facial landmarks, it may send a notification to the operator notifying the operator of an issue and may switch to inactive mode.

Motor control processor 100 may store the facial landmarks as a set of two-dimensional and three-dimensional points. Motor control processor 100 may convert the set of two-dimensional and three-dimensional points to translation and/or rotation vectors using a set of mathematical functions. Motor control processor 100 may convert the translation and/or rotation vectors to a rotational matrix using a set of mathematical functions. Motor control processor 100 may convert the rotational matrix may to a two-dimensional or three-dimensional operator movement vector using a set of mathematical functions.

In some examples, motor control processor 100 may calculate a degree of movement using a method other than facial landmark identification. For example, motor control processor 100 may include an artificial intelligence module that may generate one or more machine-learning models trained to estimate head pose using deep networks from image intensities. The artificial intelligence module may generate one or more machine-learning models to estimate a loss associated with an angle (e.g., the yaw, pitch, and roll angles associated with head movement) by combining a binned pose classification and a regression component.

Throughout operation, motor control processor 100 may be continually receiving location input from auxiliary devices 104. The location input may be obtained by external sensor data associated with auxiliary devices 104, including, but not limited to, potentiometer data. Motor control processor 100 may manage the location input through a proportional, integral, and/or derivative (PID) loop to ensure auxiliary devices 104 do not deviate from a calculated angle of rotation. Auxiliary devices 104 may be electric motors (e.g., DC, servo, etc.), hydraulic systems, pneumatic systems, electronic systems, any combination thereof, and the like.

Motor control processor 100 may compare the location input from auxiliary devices 104 to the operator movement. Motor control processor 100 may generate output according to the comparison of the location input from auxiliary devices 104 to the operator movement, including, but not limited to, change in output voltage, change in stair-step function output, change in direction, a digital signal, a wireless signal (e.g., Bluetooth, Wi-Fi, Zigbee, Z-wave, etc.), any combination thereof, or the like. In some examples, auxiliary devices 104 may operate in two distinct dimensions (e.g., one auxiliary device operates in the left-and-right direction and one auxiliary device operates in the up-and-down direction). Motor control processor 100 may alter the output to auxiliary devices 104 accordingly to ensure proper movement and/or change in movement on all planes.

Motor control processor 100 may continue operation in a continuous feedback loop with real-time or close to real-time processing. After the operator's face has been identified by motor control processor 100, motor control processor 100 may continuously monitor changes in the operator's facial landmarks and/or using deep networks via the video feed from camera 112. Motor control processor 100 may generate the operator movement vector in real-time to ensure minimal response time from auxiliary devices 104.

External control 108 may be connected to motor control processor 100 via a wired connection (e.g., universal serial bus, etc.), a wireless connection (e.g., Bluetooth, Wi-Fi, Zigbee, Z-wave, etc.), any combination thereof, or the like. External control 108 may be any device configured to control auxiliary devices 104 controlled by the operator or another individual capable of operating auxiliary devices 104. In some examples, external control may be a joystick, video game controller, smart phone application, any combination thereof, or the like. The operator or other individual may manipulate external control 108 and operate the auxiliary devices without the use of head pose estimation and/or facial landmark tracking. Motor control processor 100 can be in active or inactive mode when receiving and/or executing input from external control 108. External control 108 may override input received from head pose estimation. For example, if the operator is using head movements to move auxiliary devices 104, the operator may, at any time, begin using external control 108 and motor control processor 100 will immediately replace head movement vectors used to move auxiliary devices 104 with external control movements. As another example, if motor control processor 100 sends a notification to the operator indicating there is an issue with the video feed, the operator may begin operating auxiliary devices 104 with external control 108. External control 108 may receive power from motor control processor 100, from external power sources 116, another power source exclusively for external control 108, any combination thereof, or the like.

External power source 116 may distribute power to motor control processor 100 and auxiliary device 104. In some embodiments, external power source 116 may distribute power to elements of FIG. 1, including, but not limited to, motor control processor 100, auxiliary devices 104, camera 112, and external control 108. External power source 116 may distribute power to devices with a wired connection (e.g., USB, micro-USB, USB-C, etc.). External power source 116 may be a battery, vehicle/tractor (i.e., powered through a cigarette lighter, USB, internal A/C outlet, etc.), rechargeable battery element, solar power converter, any combination thereof, and the like.

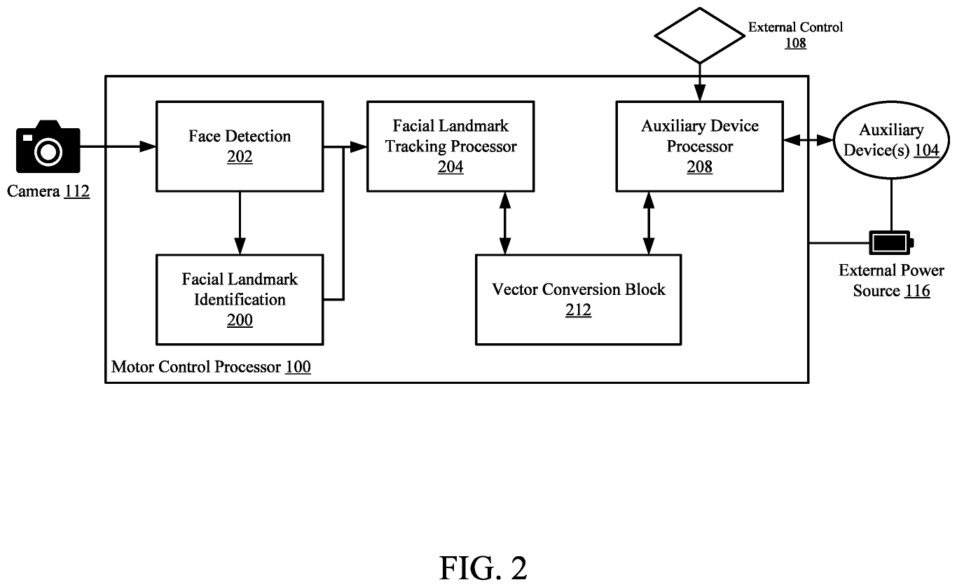

FIG. 2 illustrates a block diagram of an example processor configured to control a lighting system and/or other motor control operations with head pose estimation of an operator according to aspects of the present disclosure. The system may be implemented by motor control processor 100.

Motor control processor 100 may receive input from camera 112. The input may be a video feed. Camera 112 may be connected to motor control processor 100 via a wired connection (e.g., universal serial bus, etc.), a wireless connection (e.g., Bluetooth, Wi-Fi, Zigbee, Z-wave, etc.), any combination thereof, or the like. Camera 112 may be operated with external power source 116, receive power from motor control processor 100, have an independent power source, any combination thereof, and the like. The video feed generated by camera 112 can be one or more resolutions, including, but not limited to, 780p and/or 1080p.

Upon initial launch of the disclosed system, motor control processor 100 may launch face detection 202. Face detection 202 may utilize face detection software to identify an operator within the video feed received from camera 112. In some examples, face detection 202 may be unable to detect an operator in the video feed for one or more reasons, including, but not limited to, more than one face present in the video feed, no face present in the video feed, insufficient lighting in the video feed, an obstruction in front of the lens, an outside disturbance, any combination thereof, or the like. If face detection 202 is unable to detect an operator, motor control processor 100 may notify the operator of the issue. Motor control processor 100, via face detection 202, may continue to attempt to detect a face continuously after failure.

If an operator is detected, facial landmark identification 200 may operate facial landmark detection software on the operator's face. Facial landmarks may include, but are not limited to, outer and inner corners of eyes, corners of mouth, chin, tip of nose, scars, facial hair, hair line, jaw line, facial marks such as age spots or moles, wrinkles proximate to the eyes, wrinkles proximate to the forehead, wrinkles proximate to the cheeks, etc. In some examples, facial landmark identification 200 may be unable to detect facial landmarks on the operator due to a number of disturbances, including, but not limited to, the topology of the operator's face, insufficient video feed quality, interference with the lens of camera 112, any combination thereof, and the like.

Facial landmark tracking processor 204 may track facial landmarks identified by facial landmark identification 200. Facial landmark tracking processor may continually monitor the relative location of the facial landmarks identified by facial landmark identification 200 and translate the location into a series of two-dimensional and three-dimensional points in space. Facial landmark tracking processor 204 may receive input from camera 112 in the form of the video feed. If facial landmark tracking processor 204 cannot track the facial landmarks for one or more reasons, including, but not limited to, a sudden change in the operator's head position, an obstruction in the video feed, poor video feed resolution, any combination thereof, and the like, facial landmark tracking processor 204 may request a supplemental face detection phase in face detection 202 and/or send a notification to the operator notifying the operator of the issue. In a supplemental face detection phase in face detection 202, face detection 202 may run an iteration of the face detection software that is additional to the initial iteration present upon startup of motor control processor 100. In supplemental face detection phase, face detection 202 may continue to attempt to detect the operator's face in the video feed for a specified number of iterations. If face detection 202 is unable to identify a face in the video feed after the specified number of iterations, motor control processor 100 may send a notification to the operator notifying the operator of the issue.

In some examples, motor control processor 100 may calculate a degree of movement using a method other than facial landmark identification. For example, the motor control processor may include an artificial intelligence module that may generate one or more machine-learning models trained to estimate head pose using deep networks from image intensities. The artificial intelligence module may generate one or more machine-learning models to estimate a loss associated with an angle (e.g., the yaw, pitch, and roll angles associated with head movement) by combining a binned pose classification and a regression component. Using the binned pose classification and the regression component, the one or more machine-learning models may generate a series of two-dimensional and three-dimensional points that mirror the head movements of the operator.

Facial landmark tracking processor 204 and/or the artificial intelligence module may transmit the series of two-dimensional and three-dimensional points in space to vector conversion block 212. Vector conversion block 212 may contain a series of algorithms adapted to convert the series of two-dimensional and three-dimensional points to a two-dimensional operator movement. Vector conversion block 212 may use a specific series of mathematical functions and/or algorithms to translate the series of two-dimensional and three-dimensional points. Vector conversion block 212 may convert the series of two-dimensional and three-dimensional points to translation and/or rotation vectors, may convert the translation and/or rotation vectors to a rotational matrix, and may convert the rotational matrix to a two-dimensional operator movement. Vector conversion block 212 may transmit the operator movement to auxiliary device processor 208.

Auxiliary device processor 208 may be the processor that facilitates movement by auxiliary devices 104. Auxiliary device processor 208 may receive input from vector conversion block 212 containing the operator head movement vector that was transformed from data received by facial landmark tracking processor 204. Auxiliary device processor 208 may receive input from auxiliary devices 104 pertaining to the location of auxiliary devices 104. The location information may be obtained from one or more sources of data, including, but not limited to, sensor data (e.g., potentiometer data), voltage data, waveform data, any combination thereof, and the like. Auxiliary device processor 208 may obtain the location information, compare the location information to the operator movement, and calculate the necessary movements by auxiliary devices 104 to cause the location of auxiliary devices 104 to correspond to the operator's commands.

Auxiliary device processor 208 may transmit location information to vector conversion block 212 if the data obtained from the sources of data of auxiliary devices 104 transmit the data in format that is not usable with the operator movement. Vector conversion block 212 may perform transformations and/or conversions to the location information in order to generate usable data for auxiliary device processor 208 to utilize.

Auxiliary device processor 208 may be connected to external control 108 via a wired connection (e.g., universal serial bus, etc.), a wireless connection (e.g., Bluetooth, Wi-Fi, Zigbee, Z-wave, etc.), any combination thereof, or the like. External control 108 may be, but is not limited to, a joystick, video game controller, smart phone application, television remote, any combination thereof, or the like. The operator or other user may manipulate external control 108 and operate the auxiliary devices without the use of head pose estimation technology. Motor control processor 100 can be in active or inactive mode when receiving and/or executing input from external control 108. External control 108 may override input received from the head pose estimation method. External control 108 may receive power from motor control processor 100, from external power sources 116, another power source exclusively for external control 108, any combination thereof, and the like.

External power source 116 may distribute power to motor control processor 100 and auxiliary device 104. In some embodiments, external power source 116 may distribute power to all elements of the system, including, but not limited to, motor control processor 100, auxiliary devices 104, camera 112, and external control 108. External power source 116 may distribute power to devices with a wired connection (e.g., USB, micro-USB, USB-C, etc.). External power source 116 may be a battery, vehicle/tractor (i.e., powered through a cigarette lighter, USB, internal A/C outlet, vehicle/equipment battery, etc.), rechargeable battery element, solar power converter, any combination thereof, and the like.

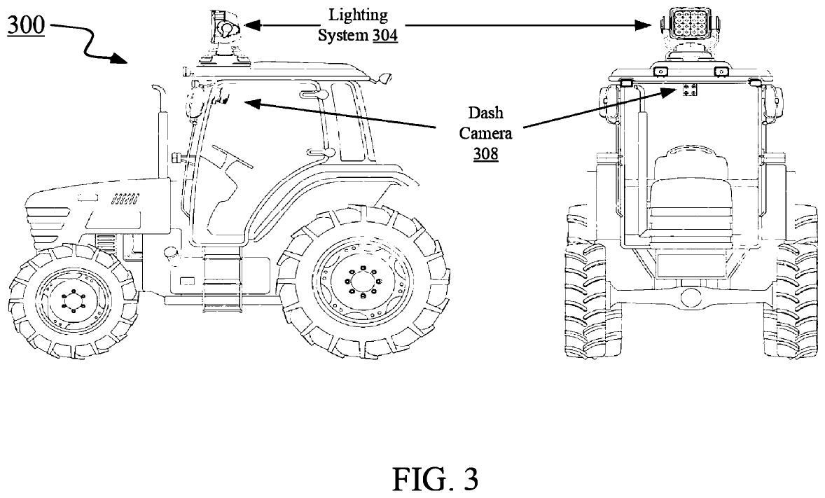

FIG. 3 depicts an example general assembly application of the system and method, in use on a standard tractor unit, according to aspects of the present disclosure. Application 300 depicts a potential embodiment of the disclosed system and method.

Lighting system 304 may be an example implementation of auxiliary devices 104. Lighting system 304 may contain one or more auxiliary devices that cause the light within lighting systems 304 to move and focus the beam of light in the area specified by the operator.

Dash camera 308 may be an example implementation of camera 112. Dash camera 308 may be mounted inside the cabin of the tractor shown in application 300. The high angle of the camera may create a higher-quality video feed due to the reduced likelihood of obstacles and/or other disturbances occurring in between the lens and the operator's face.

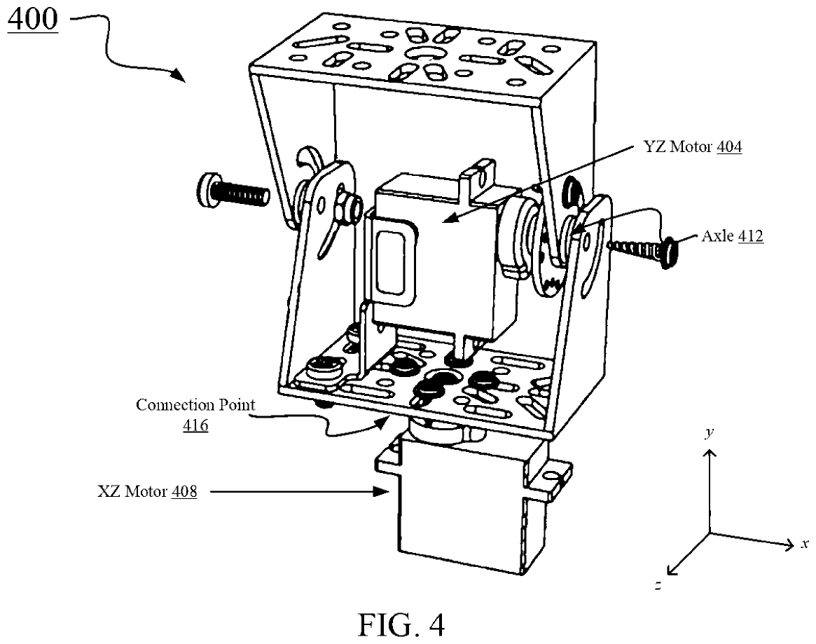

FIG. 4 depicts an example configuration of the system and method, auxiliary motors within a mounting system, according to aspects of the present disclosure. Application 400 may be an example implementation for the system and method disclosed herein.

Application 400 may contain two motors (e.g., servo motors). Each motor may move a mounting system on a two-dimensional plane within a three-dimensional plane. YZ motor 404 may move the system of application 400 in the yz-plane, while XZ motor 408 may move the system of application 400 on the xz-plane. YZ motor 404 may create a point of rotation at axle 412. XZ motor 408 may rotate the entirety of the mounting system in application 400 at connection point 416.

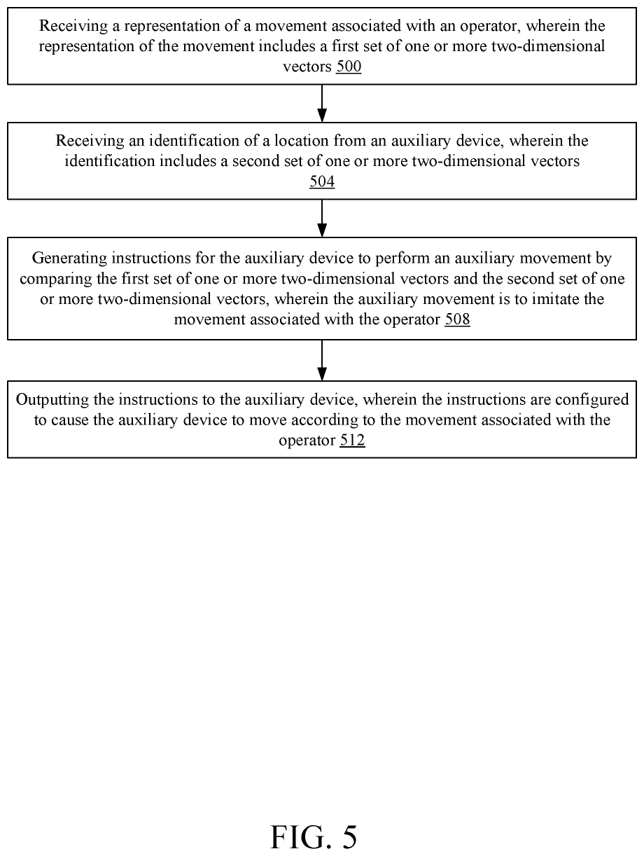

FIG. 5 illustrates a flowchart of an example process of motor control based on head pose estimation according to aspects of the present disclosure. At block 500, a computing device may receive a representation of a movement associated with the operator, wherein the representation of the movement includes a first set of one or more two-dimensional vectors.

The motor control processor may receive video input from a camera directed at the operator. The video feed transmitted to the motor control processor may be a standard definition (SD) video feed or a high definition (HD) video feed. The motor control processor may define a minimum resolution of the video feed. The minimum resolution may be based on a lowest resolution in which motor control processor can detect facial features (or other features) of the operator. The resolution of the video feed may depend on a variety of factors, including, but not limited to, lighting on the face of the operator, distance of camera from the operator, necessary response time, desired accuracy, any combination thereof, or the like.

The motor control processor may contain face detection software that recognizes the operator's face within the video feed received from the camera. The face detection software may request registration of the operator. Registration of the operator may include recording the operator's face and storing characteristics of the operator's face in local memory, including, but not limited to, distance between eyes, width of head, length of nose, any combination thereof, or the like. In some examples, the motor control processor may recognize more than one face in the video feed. For example, the operator may have a passenger in the tractor and the camera is transmitting a video feed containing both faces. The motor control processor may access the record containing the operator's face in local memory and compare the recorded facial characteristics with characteristics of the faces within the video feed. The motor control processor may decipher which face is the operator using the comparison. In some examples, the motor control processor may be unable to detect any faces in the video feed due to one or more external disturbances, including, but not limited to, insufficient light on the operator's face, a blockage between the lens and the operator, any combination thereof, and the like. The motor control processor may send a notification to the operator notifying the operator of the issue. As mentioned previously, if the motor control processor is unable to identify a face in the video feed, the motor control processor will automatically switch to inactive mode.

The motor control processor may use facial landmarks to generate the representation of the facial movement. Facial landmarks may be, but are not limited to, outer and inner corners of eyes, corners of mouth, chin, tip of nose, scars, facial hair, hair line, jaw line, facial marks such as age spots or moles, wrinkles proximate to the eyes, wrinkles proximate to the forehead, wrinkles proximate to the cheeks, etc. The facial landmarks may be stored as two-dimensional and three-dimensional points within the motor control processor. In some examples, the motor control processor may calculate the two-dimensional and three-dimensional points using a method other than facial landmark identification. For example, the motor control processor may include one or more machine-learning models trained to estimate head pose using deep networks from image intensities. The two-dimensional and three-dimensional points may be converted to translation and rotation vectors, a rotational matrix, and/or two-dimensional vector. The two-dimensional and three-dimensional points, translation and rotation vectors, rotational matrix, and two-dimensional vector may be measured against the default position of the auxiliary devices.

In some examples, the motor control processor may be unable to detect facial landmarks on the operator due to a number of disturbances, including, but not limited to, the topology of the operator's face, insufficient video feed quality, interference with the lens of the camera, any combination thereof, or the like. If the motor control processor is unable to detect facial landmarks, it may send a notification to the operator notifying the operator of an issue and may switch to inactive mode.

Motor control processor, through a facial landmark tracking processor (like facial landmark tracking processor 204), may continually monitor the relative location of the facial landmarks identified by the motor control processor and translate the location into a series of two-dimensional and three-dimensional points in space. The motor control processor may receive input from the camera in the form of the video feed.

The motor control processor may, by using frames of the video feed, calculate the operator movement by calculating the vector difference of a specific facial landmark between a frame of the video feed and a frame subsequent.

At block 504, the computer device may receive an identification of a location from an auxiliary device, wherein the identification includes a second set of one or more two-dimensional vectors. The auxiliary devices may be calibrated to a specific point in space and the location in space of the auxiliary devices may be continually monitored by the motor control processor. The default position may be the calibration position of the auxiliary devices. The motor control processor may continually monitor the location of the auxiliary devices by receiving data in the form of waveforms, speed, voltage, any combination thereof, or the like. The data may be manipulated to generate a location of the auxiliary devices relative to the default position in space. The default position may be used when measuring the operator movement of the operator and the location of the auxiliary devices to ensure accuracy and/or calibration of the motor control processor system. Throughout operation, the motor control processor may be continually receiving location input from the auxiliary devices. The location input may be obtained by external sensor data associated with the auxiliary devices, including, but not limited to, potentiometer data. The motor control processor may manage the location input through a proportional, integral, and/or derivative (PID) loop to ensure the auxiliary devices do not deviate from a calculated angle of rotation. The auxiliary devices may be electric motors (e.g., DC, servo, etc.), hydraulic systems, pneumatic systems, electronic systems, any combination thereof, and the like.

At block 508, the computer device may generate instructions for the auxiliary device to perform an auxiliary movement by comparing the first set of one or more two-dimensional vectors and the second set of one or more two-dimensional vectors, wherein the auxiliary movement is to imitate the movement associated with the operator. The motor control processor may compare the location input from the auxiliary devices to the operator movement.

At block 512, the computer device may output the instructions to the auxiliary device, wherein the instructions are configured to cause the auxiliary device to move according to the movement associated with the operator. The motor control processor may generate output according to the comparison of the location input from the auxiliary devices to the operator movement, including, but not limited to, change in output voltage, change in stair-step function output, change in direction, a digital signal, a wireless signal (e.g., Bluetooth, Wi-Fi, Zigbee, Z-wave, etc.), any combination thereof, or the like. In some examples, the auxiliary devices may operate in two distinct dimensions (e.g., one auxiliary device operates in the left-and-right direction and one auxiliary device operates in the up-and-down direction). The motor control processor may alter the output to the auxiliary devices accordingly to ensure proper movement and/or change in movement on all planes.

The external power source may distribute power to the motor control processor and auxiliary device 104. In some embodiments, the external power source may distribute power to all elements of the system, including, but not limited to, the motor control processor, the auxiliary devices, the camera, and the external control. The external power source may distribute power to devices with a wired connection (e.g., USB, micro-USB, USB-C, etc.). The external power source may be a battery, vehicle/tractor (i.e., powered through a cigarette lighter. USB, internal A/C outlet, vehicle/equipment battery, etc.), rechargeable battery element, solar power converter, any combination thereof, and the like.

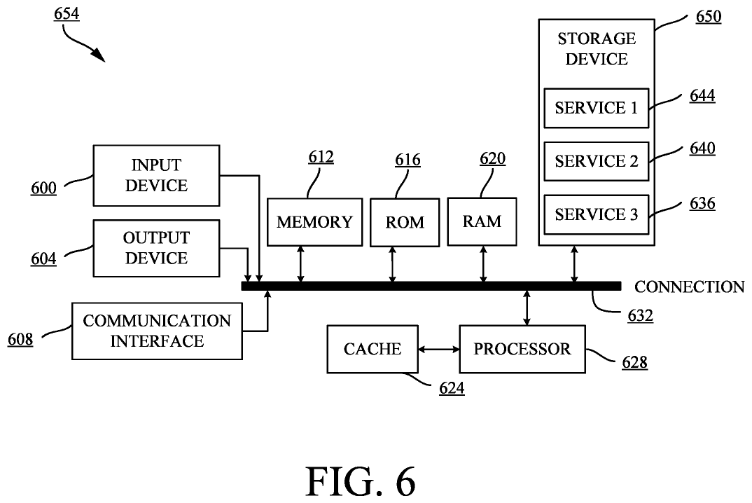

FIG. 6 illustrates an example computing device according to aspects of the present disclosure. For example, computing device 654 can implement any of the systems or methods described herein. In some instances, computing device 654 may be a component of or included within a media device. The components of computing device 654 are shown in electrical communication with each other using connection 632, such as a bus. The example computing device architecture 654 includes a processor (e.g., CPU, processor, or the like) 628 and connection 632 (e.g., such as a bus, or the like) that is configured to couple components of computing device 654 such as, but not limited to, memory 612, read only memory (ROM) 616, random access memory (RAM) 620, and/or storage device 650, to processing unit 628.

Computing device 654 can include a cache 624 of high-speed memory connected directly with, in close proximity to, or integrated within processor 628. Computing device 654 can copy data from memory 612 and/or storage device 650 to cache 624 for quicker access by processor 628. In this way, cache 624 may provide a performance boost that avoids delays while processor 628 waits for data. Alternatively, processor 628 may access data directly from memory 612. ROM 616, RAM 620, and/or storage device 650. Memory 612 can include multiple types of homogenous or heterogeneous memory (e.g., such as, but not limited to, magnetic, optical, solid-state, etc.).

Storage device 650 may include one or more non-transitory computer-readable media such as volatile and/or non-volatile memories. A non-transitory computer-readable medium can store instructions and/or data accessible by computing device 654. Non-transitory computer-readable media can include, but is not limited to magnetic cassettes, hard-disk drives (HDD), flash memory, solid state memory devices, digital versatile disks, cartridges, compact discs, random access memories (RAMs) 620, read only memory (ROM) 612, combinations thereof, or the like.

Storage device 650, may store one or more services, such as service 1 644, service 2 640, and service 3 636, that are executable by processor 628 and/or other electronic hardware. The one or more services include instructions executable by processor 628 to: perform operations such as any of the techniques, steps, processes, blocks, and/or operations described herein; control the operations of a device in communication with computing device 654; control the operations of processing unit 628 and/or any special-purpose processors; combinations therefor; or the like. Processor 628 may be a system on a chip (SOC) that includes one or more cores or processors, a bus, memories, clock, memory controller, cache, other processor components, and/or the like. A multi-core processor may be symmetric or asymmetric.

Computing device 654 may include one or more input devices 600 that may represent any number of input mechanisms, such as a microphone, a touch-sensitive screen for graphical input, keyboard, mouse, motion input, speech, media devices, sensors, combinations thereof, or the like. Computing device 654 may include one or more output devices 604 that output data to a user. Such output devices 604 may include, but are not limited to, a media device, projector, television, speakers, combinations thereof, or the like. In some instances, multimodal computing devices can enable a user to provide multiple types of input to communicate with computing device 654. Communications interface 608 may be configured to manage user input and computing device output. Communications interface 608 may also be configured to managing communications with remote devices (e.g., establishing connection, receiving/transmitting communications, etc.) over one or more communication protocols and/or over one or more communication media (e.g., wired, wireless, etc.).

Computing device 654 is not limited to the components as shown in FIG. 6. Computing device 654 may include other components not shown and/or components shown may be omitted.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor.” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method of controlling a movable device, the method comprising:
receiving a representation of a movement associated with an operator, wherein the representation of the movement includes a first set of one or more two-dimensional vectors;
receiving an identification of a location from an auxiliary device, wherein the identification includes a second set of one or more two-dimensional vectors;
generating instructions for the auxiliary device to perform an auxiliary movement by comparing the first set of one or more two-dimensional vectors and the second set of one or more two-dimensional vectors, wherein the auxiliary movement is to imitate the movement associated with the operator; and
outputting the instructions to the auxiliary device, wherein the instructions are configured to cause the auxiliary device to move according to the movement associated with the operator.

2. The method of claim 1, wherein the representation of the movement associated with the operator is based on one or more facial landmarks of the operator.

3. The method of claim 2, further comprising:
receiving a video feed from a camera recording device, wherein the video feed contains a human figure;
identifying the human figure in the video feed, wherein the human figure is the operator;
identifying, on the human figure, the one or more facial landmarks; and
tracking, through the video feed, the one or more facial landmarks.

4. The method of claim 2, further comprising:
converting the one or more facial landmarks to one or more two-and-three-dimensional points;
translating the one or more two-and-three-dimensional points to one or more three-dimensional vectors; and
converting the one or more three-dimensional vectors to a rotational matrix.

5. The method of claim 1, further comprising:
setting an operator reference vector for the operator; and
calibrating the representation of the movement associated with the operator, wherein calibrating the representation of the movement comprises of comparing the operator reference vector to the first set of one or more two-dimensional vectors.

6. The method of claim 1, further comprising:
setting an auxiliary reference vector for the auxiliary device; and
calibrating the identification of the location from the auxiliary device, wherein calibrating the identification comprises of comparing the auxiliary reference vector to the second set of one or more two-dimensional vectors.

7. The method of claim 1, wherein the instructions for the auxiliary device to perform the auxiliary movement are inputted manually.

8. The method of claim 1, wherein the auxiliary device is comprised of one or more electric motors.

9. A system comprising:
one or more processors; and
a non-transitory computer-readable medium storing instructions that, when executed by the one or more processors, cause the one or more processors to:
receive a representation of a movement associated with an operator, wherein the representation of the movement includes a first set of one or more two-dimensional vectors;
receive an identification of a location from an auxiliary device, wherein the identification includes a second set of one or more two-dimensional vectors;
generate instructions for the auxiliary device to perform an auxiliary movement by comparing the first set of one or more two-dimensional vectors and the second set of one or more two-dimensional vectors, wherein the auxiliary movement is to imitate the movement associated with the operator; and
output the instructions to the auxiliary device, wherein the instructions are configured to cause the auxiliary device to move according to the movement associated with the operator.

10. The system of claim 9, wherein the representation of the movement associated with the operator is based on one or more facial landmarks of the operator.

11. The system of claim 10, wherein the instructions further cause the one or more processors to:
receive a video feed from a camera recording device, wherein the video feed contains a human figure;
identify the human figure in the video feed, wherein the human figure is the operator;
identify, on the human figure, the one or more facial landmarks; and
track, through the video feed, the one or more facial landmarks.

12. The system of claim 10, wherein the instructions further cause the one or more processors to:
convert the one or more facial landmarks to one or more two-and-three-dimensional points;
translate the one or more two-and-three-dimensional points to one or more three-dimensional vectors; and
convert the one or more three-dimensional vectors to a rotational matrix.

13. The system of claim 9, wherein the instructions further cause the one or more processors to:
set an operator reference vector for the operator; and
calibrate the representation of the movement associated with the operator, wherein calibrating the representation of the movement comprises of comparing the operator reference vector to the first set of one or more two-dimensional vectors.

14. The system of claim 9, wherein the instructions further cause the one or more processors to:
set an auxiliary reference vector for the auxiliary device; and
calibrate the identification of the location from the auxiliary device, wherein calibrating the identification comprises of comparing the auxiliary reference vector to the second set of one or more two-dimensional vectors.

15. The system of claim 9, wherein the instructions for the auxiliary device to perform the auxiliary movement are inputted manually.

16. The system of claim 9, wherein the auxiliary device is comprised of one or more electric motors.

17. A non-transitory computer-readable storage medium storing instructions that, when executed by one or more processors, cause the one or more processors to:
output, by a video camera, a video of a human face;
track, by a first processor that receives the video of the human face, movements of the human face;
output, by a second processor, instructions for movement to a movable lighting device mount, wherein the instructions for movement match the movement of the human face; and
move, by at least one motor, the movable lighting device mount according to the instructions for movement.
